(19) United States
(12) Patent Application Publication
(10) Pub. No.: US 2019/0203856 A1
(43) Pub. Date: Jul. 4, 2019

(54) TUBULAR, EQUIPMENT AND METHOD OF FORMING THE SAME

(71) Applicants: SAINT-GOBAIN PERFORMANCE PLASTICS CORPORATION, Solon, OH (US); CASE WESTERN RESERVE UNIVERSITY, Cleveland, OH (US)

(72) Inventors: Kevin M. MCCAULEY, Akron, OH (US); Joao MAIA, Shaker Heights, OH (US); Tyler SCHNEIDER, Shaker Heights, OH (US)

(21) Appl. No.: 16/233,257

(22) Filed: Dec. 27, 2018

Related U.S. Application Data
(60) Provisional application No. 62/610,796, filed on Dec. 27, 2017.

(51) Int. Cl. F16L 9/12; F02M 55/02; F02M 37/00

(52) U.S. Cl. CPC F16L 9/12; F02M 37/0017; F02M 55/02

(57) ABSTRACT

A tubular for fuel delivery including a plurality of first-type layers; and a plurality of second-type layers each disposed between a pair of adjacent first-type layers, wherein the plurality of first-type layers includes at least two first-type layers, wherein the plurality of second-type layers includes at least two second-type layers, and wherein a Melt Flow Index, MFI₁, of each of the plurality of first-type layers is different than a Melt Flow Index, MFI₂, of each of the plurality of second-type layers, as measured at a same temperature, wherein the tubular for fuel delivery has a resistance to fuel permeation of less than about 15 g/day/m².

### CROSS-REFERENCE TO RELATED APPLICATIONS

This application claims priority under 35 U.S.C. § 119(e) to U.S. Provisional Patent Application No. 62/610,796, entitled “TUBULAR, EQUIPMENT AND METHOD OF FORMING THE SAME”, by Kevin M. McCauley et al., filed Dec. 27, 2017, which is assigned to the current assignee hereof and incorporated herein by reference in its entirety.

### FIELD OF THE DISCLOSURE

The present disclosure relates to tubulars and equipment and processes associated with the formation thereof.

### RELATED ART

Traditional tubular structures having multi-layered constructions are limited in the number of layers forming the tubular sidewall. Traditional processes of forming tubular structures limit the tubular structures to as few as three layers and as many as twelve layers. As a result of fewer layers, the layers are typically thick, rigid, and unsuitable for many tubular applications. Moreover, introduction of weld lines separating portions of the layers creates weak points subject to failure during use.

Industries continue to demand improved tubulars as well as processes and equipment associated with the manufacture thereof to provide fluid transport in difficult environments.

### SUMMARY

In an embodiment, a tubular for fuel delivery includes a plurality of first-type layers; and a plurality of second-type layers each disposed between a pair of adjacent first-type layers, wherein the plurality of first-type layers includes at least two first-type layers, wherein the plurality of second-type layers includes at least two second-type layers, and wherein a Melt Flow Index, MFI₁, of each of the plurality of first-type layers is different than a Melt Flow Index, MFI₂, of each of the plurality of second-type layers, as measured at a same temperature, wherein the tubular for fuel delivery has a resistance to fuel permeation of less than about 15 g/day/m².

In an embodiment, a tubular for fuel delivery includes an elongated structure including at least ten layers, the layers including: a plurality of first-type layers; and a plurality of second-type layers, wherein the first-type layers have a first viscosity, V₁, as measured at a reference temperature, wherein the second-type layers have a second viscosity, V₂, as measured at the reference temperature, and wherein V₁/V₂ is at least 1.01, wherein the tubular for fuel delivery has a resistance to fuel permeation of less than about 15 g/day/m².

In yet another embodiment, a tubular for fuel delivery includes: an elongated structure including a plurality of layers, wherein an innermost layer defines an aperture extending along at least a portion of the elongated structure, wherein radially adjacent layers comprise different materials, and wherein the different materials have different viscosities as measured at a same reference temperature, wherein the tubular for fuel delivery has a resistance to fuel permeation of less than about 15 g/day/m².

### BRIEF DESCRIPTION OF THE DRAWINGS

Embodiments are illustrated by way of example and are not limited in the accompanying figures.

FIG. 1 includes a perspective view of a tubular in accordance with an embodiment.

FIG. 2 includes a cross-sectional elevation view of the tubular as seen along Line A-A in FIG. 1 in accordance with an embodiment.

FIG. 3 includes a perspective view of an equipment used to form a tubular in accordance with an embodiment.

FIG. 4 includes a perspective view of a rotating element of the equipment in accordance with an embodiment.

FIG. 5 includes a graphical depiction of fuel permeation resistance of exemplary multilayer structures.

FIG. 6 includes multiple views of an exemplary 65-layer structure in accordance with an embodiment and described in Example 4.

FIG. 7 includes multiple views of an exemplary 129-layer structure in accordance with an embodiment and described in Example 5.

FIG. 8 includes multiple view of an exemplary 129-layer structure in accordance with an embodiment and described in Example 6.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

Unless otherwise defined, the terms “vertical,” “horizontal,” and “lateral” are intended to refer to directional orientations as they relate to the orientations illustrated in the figures.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the tubular and multiplex arts.

Tubulars in accordance with one or more embodiments described herein can generally include an elongated structure formed from a plurality of layers, such as at least 2 layers, at least 5 layers, at least 25 layers, at least 100 layers, or even at least 1000 layers. The layers can include a plurality of first-type layers and a plurality of second-type layers arranged together around the circumference of the elongated structure. In an embodiment, adjacent layers of the plurality of first-type layers can be spaced apart from one another by at least one layer of the plurality of second-type layers. The first- and second-type layers can differ from one another in a particular attribute, such as, for example, viscosity at a reference temperature, permeability to particular substances, strength, elasticity, or any combination thereof.

The tubular can define a central aperture extending along at least a portion of the elongated structure. In an embodiment, the aperture can extend along at least 25% of a length of the tubular, along at least 50% of the length of the tubular, along at least 75% of the length of the tubular, or along at least 99% of the length of the tubular. In an embodiment, the aperture can extend along the entire length of the tubular.

Fluids and other medium can be transported through the aperture and delivered to a particular location, such as a fuel injector, a container such as a mixing bag, a pharmaceutical component, a medical device, a food and beverage product, or any other similar device which uses or accepts the fluid or other medium being transported thereto. In a particular embodiment, the tubular is for fuel delivery. In an embodiment, the tubular is for any engine envisioned. For instance, the engine may be for power equipment such as handheld power equipment, a marine engine, and the like. Applications for the tubular are numerous and may be used in automotive applications, or other applications where chemical resistance, and/or low permeation to gases and hydrocarbons are desired.

In embodiment, the resulting tubular for fuel delivery may have further desirable physical and mechanical properties. In an embodiment, the tubular for fuel delivery has desirable resistance to fuel permeation, such as a resistance to fuel permeation of less than about 15 g/day/m², when measured by SAE J30 and SAE J1737 (in compliance with the California Air Resources Board). In an embodiment, the tubular for fuel delivery are kink-resistant and appear transparent or at least translucent. For instance, the tubular for fuel delivery may have a light transmission greater than about 2%, or greater than about 5% in the visible light wavelength range. In particular, the tubular for fuel delivery has desirable flexibility and substantial clarity or translucency. For example, the tubular for fuel delivery has a bend radius of at least 0.5 inches. For instance, the tubular for fuel delivery may advantageously produce low durometer tubes. For example, the tubular for fuel delivery has a Shore A durometer of between about 35 and about 90, such as between about 55 to about 70 having desirable mechanical properties may be formed. Such properties are indicative of a flexible material.

Referring to the figures, FIG. 1 includes a perspective view of a tubular 100 in accordance with an embodiment. The tubular 100 has a length, L, generally parallel with a central axis 102 and a radius, R, extending perpendicular to the central axis 102. An aperture 104 can be defined by an inner layer 106 of the tubular 100. The aperture 104 can extend along at least 25% of a length of the tubular 100, along at least 50% of the length of the tubular 100, along at least 75% of the length of the tubular 100, or along at least 99% of the length of the tubular 100. In an embodiment, the aperture 104 can extend along the entire length of the tubular 100. The aperture 104 can have a uniform profile as measured along the length, L, of the tubular 100. In another embodiment, the size or shape of the aperture 104 may change along the length, L, of the tubular 100 such that the size or shape of the aperture 104 is different at a first location as compared to a second location.

An outer layer 108 of the tubular can extend along at least 10% of the outer surface area of the tubular 100, along at least 50% of the outer surface area of the tubular 100, along at least 75% of the outer surface area of the tubular 100, or along at least 99% of the outer surface area of the tubular 100. In an embodiment, the outer layer 108 can extend along the entire outer surface area of the tubular 100. In a particular embodiment, at least one of the inner layer 106, the outer layer 108, or combination thereof can consist essentially of a different material than any layer disposed between the inner layer 106 and the outer layer 108. By way of a non-limiting example, at least one of the inner layer 106, the outer layer 108, or combination thereof can differ from the other layers in thickness, material, porosity, flexibility, elasticity, inertness, or any combination thereof.

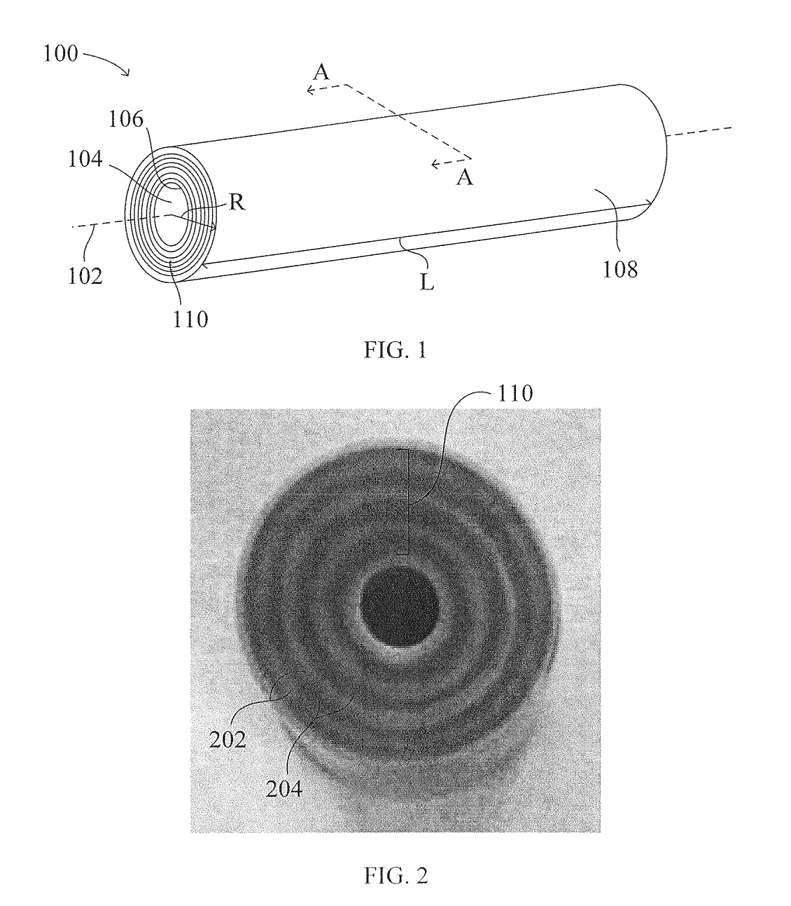

In an embodiment, layers 110 between the inner layer 106 and outer layer 108 can include first-type layers and second type layers. For example, referring to FIG. 2, the layers 110 can include a plurality of first-type layers 202 and a plurality of second-type layers 204. In another embodiment, the layers 110 can include third-type layers, fourth-type layers, fifth-type layers, sixth-type layers, seventh-type layers, or any number of other-type layers different from the first- and second-type layers 202 and 204. In an embodiment, each different-type layer can differ from the other layers in at least one way, such as thickness, material, porosity, flexibility, chemical inertness, permeability, or any combination thereof.

In an embodiment, each first-type layer 202 is spaced apart from a radially adjacent first-type layer 202 by a second-type layer 204. This alternating arrangement can enhance strength, permeability, flexibility, or any other suitable mechanical property of the tubular 100. Further, use of alternating layers may reduce tubular failure by mitigating the effect of a punctured or otherwise damaged layer in the tubular. For example, a hole formed by a sharp object might penetrate an outermost 50 layers of a tubular including 100 layers. By alternating the properties of the layers, the underlying 50 layers can maintain the original properties of the tubular. To the contrary, forming an outermost 50 layers of the tubular to have a first property and an innermost 50 layers of the tubular to have a second property might result in failure of the tubular with respect to the first property. That is, a hole formed in the outer 50 layers can mitigate the desired properties created by the outermost 50 layers.

In an embodiment, the tubular 100, or one or more layers 110 disposed therein, can provide a barrier against escape of gases, liquids, or a combination thereof from the aperture 104. In a particular embodiment, the tubular 100 may prevent escape of hydrocarbons, alcohols, medical media, food or beverage related media, and the like.

In a particular instance, the tubular 100 can include at least 2 layers, at least 5 layers, at least 10 layers, at least 20 layers, at least 50 layers, at least 100 layers, at least 200 layers, at least 500 layers, at least 1000 layers, at least 2000 layers, at least 3000 layers, at least 4000 layers, or at least 5000 layers. In another instance, the tubular 100 includes no greater than 20,000 layers, no greater than 10,000 layers, or no greater than 5,000 layers. The tubular 100 can include any number of layers 110 within a range between the values above, such as in a range of 5 layers to 10,000 layers, in a range of 20 layers to 5000 layers, or in a range of 100 layers to 3000 layers.

In an embodiment, the first- and second-type layers 202 and 204 can be staggered using a sequence other than 1:1 (alternating each layer). By way of a non-limiting example, adjacent first-type layers 202 can be spaced apart by two second-type layers 204, three second-type layers 204, or any other suitable number of second-type layers 204. In another example, different pairs of adjacent first-type layers 202 can be spaced apart by a different number of second-type layers 204. In a particular embodiment, first- or second-type layers 202 and 204 may be more highly concentrated at a particular region of the tubular 100. For example, and by way of a non-limiting embodiment, at locations near the aperture 104, the tubular 100 can include five second-type layers 204 between adjacent first-type layers 202 whereas near the outer surface 208 of the tubular 100 each pair of adjacent first-type layers 202 can be spaced apart by only one second-type layer 204. The arrangement and spatial distribution of layers 110 can occur using any sequence. In an embodiment, a ratio of a number of first-type layers 202 to second-type layers 204 [first-type layers/second-type layers] can be in a range of 0.01 to 100, such as in a range of 0.1 to 75, in a range of 1 to 20, or in a range of 1 to 5.

As illustrated in FIG. 2, in an embodiment, the layers 110 can have the same thickness or a different thickness as compared to one another. For example, the first-type layers can have a first thickness and the second-type layers can have a second thickness different from the first thickness. In an embodiment, the first thickness is at least 101% the second thickness, at least 105% the second thickness, at least 110% the second thickness, at least 150% the second thickness, at least 200% the second thickness, or at least 500% the second thickness. In another embodiment, the first thickness is no greater than 10,000% the second thickness. In another embodiment, the second thickness is at least 101% the first thickness, at least 105% the first thickness, at least 110% the first thickness, at least 150% the first thickness, at least 200% the first thickness, or at least 500% the first thickness. In yet a further embodiment, the second thickness is no greater than 10,000% the first thickness. In an embodiment, the first thickness is 50 nanometers to 2000 nanometers, such as 50 nanometers to 1000 nanometers, such as 50 nanometers to 500 nanometers, such as 100 nanometers to 500 nanometers, such as 200 nanometers to 500 nanometers, or even 200 nanometers to 400 nanometers. In an embodiment, the second thickness is 50 nanometers to 2000 nanometers, such as 50 nanometers to 1000 nanometers, such as 50 nanometers to 500 nanometers, such as 100 nanometers to 500 nanometers, such as 200 nanometers to 500 nanometers, or even 200 nanometers to 400 nanometers. In an embodiment, the layers 110 have any cumulative thickness envisioned. In a particular embodiment, the layers 110 have a cumulative thickness of 10 micrometers to 10000 micrometers, such as 10 micrometers to 5000 micrometers, such as 10 micrometers to 1000 micrometers, such as 10 micrometers to 500 micrometers, or even 25 micrometers to 100 micrometers.

Third-type, fourth-type, fifth-type, sixth-type, seventh-type, or any other type layer can be included in the layers 110. The third-type, fourth-type, fifth-type, sixth-type, seventh-type, etc. layers can be arranged in predetermined sequences (e.g., from an inner position to an outer position: first-type, second-type, third-type, first-type, second-type, third-type) or in a random distribution (e.g., from an inner position to an outer position: first-type, sixth-type, second-type, second-type, fourth-type, seventh-type, first-type, etc.). The spatial arrangement of layers 110 can be adjusted or changed based on the particular application or limitations of the processing equipment.

In an embodiment, the tubular 100 can further include the inner layer 106, the outer layer 108, or combination thereof having at least a different thickness (not illustrated) than the layers 110. In a particular embodiment, the inner layer 106,outer layer 108, or combination thereof can be extruded on the tubular 100, for example, as the tubular 100 is ejecting from a die (described in greater detail below). As illustrated, the inner layer 106 is disposed along an innermost surface of the tubular 100. As illustrated, the outer layer 108 is disposed along an outermost surface of the tubular 100. In a particular embodiment, the inner layer 106, outer layer 108, or combination thereof may provide any desirable properties to the final tubular 100. For instance, the inner layer, outer layer, or combination thereof may provide any number of properties such as, for example, structural integrity, barrier properties, and flexibility.

Any material is envisioned for the inner layer 106, outer layer 108, or combination thereof. In an embodiment, the inner layer 106, outer layer 108, or combination thereof may be a thermoplastic polymer. Exemplary polymers include fluoroelastomers (FKM), perfluoro-elastomers (FFKM), tetrafluoroethylene/propylene rubbers (FEPM), poly(methyl methacrylate) (PMMA), acrylonitrile butadiene styrene (ABS), a polyamide, polybenzimidazole (PBI), polycarbonate (PC), polyether sulfone (PES), poly ether ether ketone (PEEK), polyetherimide (PEI), polyethylene (PE), polyisoprene (IR), polybutadiene (BR), polyphenylene oxide (PPO), polyphenylene sulfide (PPS), polypropylene (PP), polystyrene, polyvinyl chloride (PVC), polyvinylidene fluoride (PVDF), polytetrafluoroethylene (PTFE), styrene ethylene butylene styrene (SEBS), poly(styrene-butadiene-styrene) (SBS), styrene-butadiene copolymer (SBR), thermoplastic polyurethane (TPU), ethylene vinyl alcohol (EVOH), natural rubber, or any combination thereof. The inner layer 106 and outer layer 108, when both present, may be the same or different polymers. In an embodiment, each of the inner layer 106 or outer layer 108 may have a thickness of 10 micrometers to 20000 micrometers, such as 10 micrometers to 10000 micrometers, such as 50 micrometers to 10000 micrometers, or even 50 micrometers to 5000 micrometers.

In an embodiment, the radius, R, of tubular 100 may have a total thickness of 10 micrometers to 40000 micrometers, such as 50 micrometers to 20000 micrometers, or even 100 micrometers to 10000 micrometers.

As illustrated in FIG. 2, the tubular 100 can be essentially free of weld lines. As used herein, a body that is “essentially free” of weld lines includes no readily discernable visual junction between halves, thirds, quarters, etc. of the tubular. Whereas traditional multi-layered tubes include noticeable junctions formed between halves (e.g., at diametrically opposite sides of the tube), the tubular 100 may not include a readily discernable visual junction. That is, as illustrated in FIG. 2, the layers 110 can appear continuous around the circumference of the tubular 100. The reduction or elimination of weld lines can increase structural strength of the tubular 100 by reducing the occurrence of weakened portions of the tubular which may become susceptible to leakage or other similarly undesirable characteristics. As described in greater detail below, the omission of weld lines can occur through rotation of the tubular 100 during at least a portion of the formation process. Rotating an inner member, an outer member, or a combination thereof of a structure used to form the tubular 100 can stagger and even eliminate the occurrence of weld lines.

In an embodiment, the first-type layer 202 can differ from the second-type layer 204 in viscosity, as measured at a reference temperature. In a particular embodiment, the reference temperature is an elevated temperature, such as a melt temperature of the first- and second-type layers 202 and 204. In a more particular embodiment, the reference temperature is a melt temperature associated with the higher melt temperature of the first- or second-type layers 202 or 204. For example, by way of a non-limiting embodiment, the first-type layer 202 can have a melt temperature of approximately 260° C. and the second-type layer 204 can have a melt temperature of approximately 330° C. In this example, the reference temperature can be 330° C. as both the first- and second-type layers 202 and 204 are melted and operable at 330° C.

In an embodiment, the first-type layer 202 can have a first viscosity, V₁, as measured at the reference temperature, and the second-type layer 204 can have a second viscosity, V₂, as measured at the reference temperature, where V₁ is different than V₂. In an embodiment, a ratio of V₁/V₂ is at least 1.01, at least 1.05, at least 1.5, at least 2.0, at least 3.0, at least 4.0, at least 5.0, at least 10.0, or at least 25.0. In another embodiment, the ratio of V₁/V₂ is no greater than 200.0, no greater than 150.0, no greater than 100.0, no greater than 75.0, or no greater than 50.0. While traditional multi-layered tubes can have materials with different naturally occurring viscosities, the materials in traditional multi-layered tubes include fillers which modify the viscosity of the materials in the different layers of the tubes to be the same. Thus, multi-layered tubes formed by traditional processes and assemblies may appear to have layers with different viscosities given the different chemical compositions therebetween, however fillers introduced to the materials render the viscosities thereof substantially the same. To date, no multi-layered tube forming process or equipment has provided formation of multi-layered tubes with layers formed of materials with different viscosities at a reference temperature, such as the melt temperature of the materials.

In an embodiment, the first-type layer 202 can have a first Melt Flow Index, MFI₁, and the second-type layer 204 can have a second Melt Flow Index, MFI₂, different from MFI₁. In an embodiment, MFI₁ is at least 1.01 MFI₂, at least 1.05 MFI₂, at least 1.1 MFI₂, at least 1.5 MFI₂, at least 2.0 MFI₂, at least 3.0 MFI₂, at least 4.0 MFI₂, at least 5.0 MFI₂, or at least 10.0 MFI₂. In another embodiment, MFI₁ is no greater than 200.0 MFI₂, no greater than 100.0 MFI₂, or no greater than 50 MFI₂. Melt Flow Index (MFI) is a measure of the flow of a polymer, defined as the mass of polymer flowing through a capillary of a specific diameter and length under a preset pressure and temperature for a duration of ten minutes. Melt Flow Index can be calculated in accordance with ASTM D1238 or ISO 1133-1. Melt Flow Index is typically inverse to viscosity.

In embodiments including, for example, third-type layers, fourth-type layers, fifth-type layers, sixth-type layers, seventh-type layers, etc. the Melt Flow Index for the layers may be different or the same. For example, in tubulars 100 including a third-type layer, the third-type layer can have a third Melt Flow Index, MFI₃, which is different from at least one, such as both, MFI₁ and MFI₂. In an embodiment, MFI₃ is less than MFI₁ and MFI₂. In another embodiment, MFI₃ is between MFI₁ and MFI₂. In yet a further embodiment, MFI₃ is greater than MFI₁ and MFI₂. In another embodiment, MFI₃, is substantially the same as at least one of the first-type layer, MFI₁, or second-type layer, MFI₂. Similarly, the Melt Flow Indexes of the fourth-type layers, fifth-type layers, sixth-type layers, seventh-type layers, etc. can be different from MFI₁, MFI₂, or MFI₃.

In an embodiment, the layers 110, such as first-type layers 202 and second-type layers 204 can include a polymer, such as a thermoplastic. In a more particular embodiment, the first-type layers 202 and second-type layers 204 can include different polymers as compared to one another, such as different thermoplastics. For example, the layers 110 can include fluoroelastomers (FKM), perfluoro-elastomers (FFKM), tetrafluoroethylene/propylene rubbers (FEPM), or any combination thereof. Other exemplary polymers include poly(methyl methacrylate) (PMMA), acrylonitrile butadiene styrene (ABS), a polyamide, polybenzimidazole (PBI), polycarbonate (PC), polyether sulfone (PES), poly ether ether ketone (PEEK), polyetherimide (PEI), polyethylene (PE), polyisoprene (IR), polybutadiene (BR), polyphenylene oxide (PPO), polyphenylene sulfide (PPS), polypropylene (PP), polystyrene, polyvinyl chloride (PVC), polyvinylidene fluoride (PVDF), polytetrafluoroethylene (PTFE), styrene ethylene butylene styrene (SEBS), poly(styrene-butadiene-styrene) (SBS), styrene-butadiene copolymer (SBR), thermoplastic polyurethane (TPU), ethylene vinyl alcohol (EVOH), natural rubber, or any combination thereof. In an embodiment, the layers 110 can include a polyamide, a polyvinylidene fluoride (PVDF), a thermoplastic polyurethane (TPU), ethylene vinyl alcohol (EVOH), or a combination thereof.

In an embodiment, at least one of the layers 110 can include a filler material. Exemplary fillers include fibers, glass fibers, carbon fibers, aramids, inorganic materials, ceramic materials, carbon, carbon black, silica, glass, graphite, aluminum oxide, molybdenum sulfide, bronze, silicon carbide, woven fabric, powder, sphere, thermoplastic material, polyimide, polyamidimide, polyphenylene sulfide, polyethersulofone, polyphenylene sulfone, liquid crystal polymers, polyetherketone, polyether ether ketones, aromatic polyesters, mineral materials, wollastonite, barium sulfate, or any combination thereof.

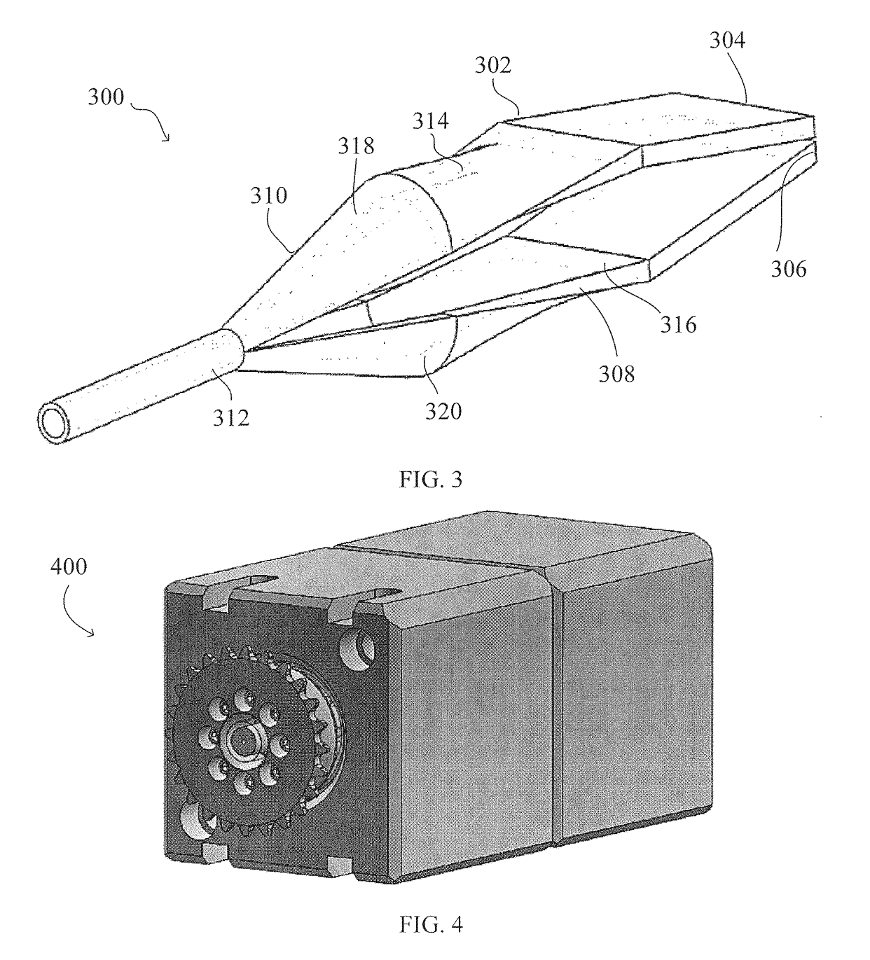

FIG. 3 illustrates a simplified view of an equipment 300 adapted to form tubulars in accordance with previously described embodiments. The equipment 300 includes a die 302 which has a first opening 304 and a second opening 306, a reshaping portion 308, a joining element 310, and a securing element 312. The first opening 304 is adapted to receive a first laminated structure (not illustrated). The second opening 306 is adapted to receive a second laminated structure (not illustrated). In an embodiment, the first opening 304 is parallel with the second opening 306. In another embodiment, at least one of the first and second openings 304 and 306 is generally planar. In yet a further embodiment, the first opening 304 has a first lateral side and a second lateral side opposite the first lateral side and the second opening 306 has a first lateral side and a second lateral side opposite the first lateral side, where the first lateral sides of the first and second openings 304 and 306 lie along a straight line, the second lateral sides of the first and second openings 304 and 306 lie along a straight line, and wherein the first line is parallel with the second line. The first and second openings 304 and 306 can define paths 314 and 316 to the reshaping portion 308 of the die 302. In an embodiment, the die 302 further includes an adapter (not illustrated) adapted to transfer at least one of the first and second laminated structures to the first or second opening 304 or 306, respectively.

In an embodiment, the reshaping portion 308 includes two portions 318 and 320 each adapted to receive one of the first and second laminated structures. As the laminated structures are urged through the reshaping portion 308, the laminated structures are reshaped to semi-circular geometries. The first laminated structure can form a first semi-circular geometry and the second laminated structure can form a second semi-circular geometry. In an embodiment, the first semi-circular geometry can be substantially similar to the second semi-circular geometry.

After being shaped, the first and second semi-circular geometries can be joined together by the joining element 310. The joining element 310 can bring circumferential ends of the first and second semi-circular geometries together. The securing element 312 can then secure the first semi-circular geometry and the second semi-circular geometry together.

The securing element 312 can include a component adapted to secure the first and second semi-circular geometries together. In a particular embodiment, the securing element 312 includes a welding element adapted to melt at least a portion of the circumferential end of the first semi-circular geometry with at least a portion of the circumferential end of the second semi-circular geometry. The securing element 312 can be positioned adjacent to the joining element 310 such that the first and second semi-circular geometries are secured together at a proper relative location, orientation, or position. In a particular embodiment, the securing element 312 is adapted to secure the first and second semi-circular geometries together at a time substantially simultaneous with the passage of the first and second semi-circular geometries through the joining element 310.

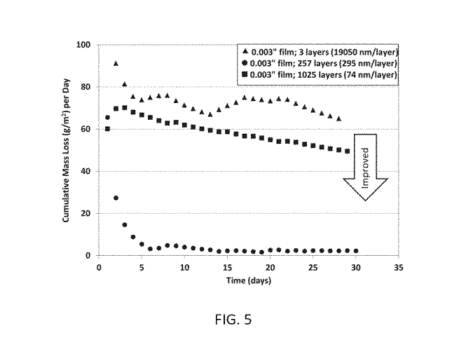

In an embodiment, the die 302 can include or be coupled to a rotating element 400 (FIG. 4) adapted to rotate at least a portion of the first semi-circular geometry, a portion of the second semi-circular geometry, or a combination thereof. The rotating element 400 can be externally or internally driven and can rotate one or more surfaces of the die 302. The rotating element 400 can be driven, for example, by a motor or any other suitable driving element, optionally connected to rotatable surfaces through one or more pulleys, gears, racks, pinions, screws, other suitable mechanical mechanisms, or any combination thereof. The rotating element 400 can rotate, or provide a rotating biasing force against at least one of the first and second semi-circular geometries along an inner surface thereof, an outer surface thereof, or along a combination of the inner and outer surfaces thereof. In a particular embodiment, the rotating element 400 can provide a first rotational force along an inner surface of the tubular 100 and a second rotational force along an outer surface of the tubular 100, where the first and second rotational forces are oriented in opposite, or substantially opposite, directions as compared to one another.

In a particular instance, the rotating element 400 is adapted to rotate the tubular 100 during formation thereof in a range of 0.1 revolutions per minute (RPM) to 500 RPM, in a range of 1 RPM to 100 RPM, in a range of 10 RPM to 90 RPM, in a range of 25 RPM to 88 RPM, or in a range of 50 RPM to 85 RPM. In a more particular instance, the rotating element 400 is adapted to rotate the tubular 100 or a portion thereof in a range of 80 RPM and 85 RPM. It is noted that the multiplex character of the tubular 100 can be generally maintained prior to, during, and after passing through the rotating element 400 or a rotating surface driven by the rotating element 400.

Rotation of the tubular 100, or portions thereof, can reduce the occurrence or even eliminate weld lines from the tubular. As described above, the elimination of weld lines can, for example, increase physical strength of the tubular 100 and increase barrier strength of the tubular against escape of gas or liquid.

In a particular embodiment, the process of forming the tubular 100 can occur at a constant temperature. That is, the temperature of the tubular 100 as it exits the die 302 and along portions thereof during formation within the die 302 can be maintained at a generally constant temperature (i.e., within ±10° C., within ±8° C., within ±6° C., within ±4° C., within ±2° C., or within ±1° C.).

In an embodiment, at least one portion of the equipment 300 can be detachable from the die 302. For example, in a particular embodiment, the first or second opening 304 or 306 can be detachable from the die 302. In a particular embodiment, the first or second opening 304 or 306 (including paths 314 and 316) can be detachable from the die 302. In another embodiment, the reshaping portion 308 (including portions 318 and 320) can be detachable from the die 302. In a further embodiment, the joining element 310 can be detachable from the die 302. In another embodiment, joining element 310 can be detachable from the die 302. In yet a further embodiment, the securing element 312 can be detachable from the die. In a more particular embodiment, at least one of the first opening 304, the second opening 306, the reshaping portion 308, the joining element 310, and the securing element 312 can be interchangeable between a plurality of options, each option having a unique configuration different from the other option, for example, in size, shape, material, or a combination thereof.

To form the tubular 100, the first and second laminated structures can be urged into a first portion of the die 302, the first portion including the openings 304 and 306. At least one, such as both, of the laminated structures can be urged into the die such that the first laminated structure forms the first semi-circular geometry and the second laminated structure forms the second semi-circular geometry. In an embodiment, formation of the first and second semi-circular geometries can occur in the reshaping portion 308 of the die 302. The first and second semi-circular geometries can then be brought into contact with one another, such as along circumferential ends thereof and joined to form a circular geometry tube.

Rotational force, such as rotational force supplied by the rotating element 400, can be selectively applied along at least one of the first and second semi-circular geometries or the tubular 100 to reduce the occurrence of weld lines within the finally formed tubular 100. In an embodiment, rotational force is applied simultaneously, or generally simultaneously, with joining of the first and second semi-circular geometries. In another embodiment, rotational force is applied simultaneously, or generally simultaneously, with securing the first and second semi-circular geometries together.

In an embodiment, the first and second laminated structures can be formed by providing a plurality of first-type layers, such as first-type layers 202 described above, and a plurality of second-type layers, such as second-type layers 204 described above. The first- and second-type layers 202 and 204 can be arranged in a desired arrangement (described above) and laminated. Lamination can occur with the application of heat, calendaring, or a combination thereof. In an embodiment, the laminated structures are generally planar during at least a portion of the process of formation thereof. In another embodiment, the first and second laminated structures can have a same arrangement as compared to one another. That is, the first laminated structure can have a first arrangement of layers and the second laminated structure can have a second arrangement of layers the same as the first arrangement of layers. In another embodiment, the first and second arrangements of layers can be different from one another. In an embodiment, the first laminated structure has a thickness the same as the second laminated structure. In another embodiment, the first laminated structure has a different thickness as compared to the second laminated structure. Adhesive or other intermediary layers can be disposed between one or more adjacent layers of the first or second laminated structures.

Many different aspects and embodiments are possible. Some of those aspects and embodiments are described below. After reading this specification, skilled artisans will appreciate that those aspects and embodiments are only illustrative and do not limit the scope of the present invention. Exemplary embodiments may be in accordance with any one or more of the embodiments as listed below.

Embodiment 1. A tubular for fuel delivery comprising:

a plurality of first-type layers; and

a plurality of second-type layers each disposed between a pair of adjacent first-type layers,

wherein the plurality of first-type layers includes at least three first-type layers, wherein the plurality of second-type layers includes at least three second-type layers, and wherein a Melt Flow Index, MFI₁, of each of the plurality of first-type layers is different than a Melt Flow Index, MFI₂, of each of the plurality of second-type layers, as measured at a same temperature, wherein the tubular for fuel delivery has a resistance to fuel permeation of less than about 15 g/day/m².

Embodiment 2. A tubular for fuel delivery comprising:

an elongated structure including at least ten layers, the layers comprising:
a plurality of first-type layers; and
a plurality of second-type layers,

wherein the first-type layers have a first viscosity, V₁, as measured at a reference temperature, wherein the second-type layers have a second viscosity, V₂, as measured at the reference temperature, and wherein V₁/V₂ is at least 1.01, at least 1.05, at least 1.5, at least 2.0, at least 3.0, at least 4.0, at least 5.0, at least 10.0, or at least 25.0, wherein the tubular for fuel delivery has a resistance to fuel permeation of less than about 15 g/day/m².

Embodiment 3. A tubular for fuel delivery comprising:

an elongated structure including a plurality of layers, wherein an innermost layer defines an aperture extending along at least a portion of the elongated structure, wherein radially adjacent layers comprise different materials, and wherein the different materials have different viscosities as measured at a same reference temperature, wherein the tubular for fuel delivery has a resistance to fuel permeation of less than about 15 g/day/m².

Embodiment 4. The tubular for fuel delivery of any one of embodiments 1 and 3, wherein the first-type layers have a first viscosity, V₁, as measured at a reference temperature, wherein the second-type layers have a second viscosity, V₂, as measured at the reference temperature, and wherein V₁/V₂ is at least 1.01, at least 1.05, at least 1.5, at least 2.0, at least 3.0, at least 4.0, at least 5.0, at least 10.0, or at least 25.0.

Embodiment 5. The tubular for fuel delivery of any one of embodiments 1, 3, and 4, wherein V₁/V₂ is no greater than 200.0, no greater than 100.0, or no greater than 50.

Embodiment 6. The tubular for fuel delivery of any one of embodiments 2-5, wherein the reference temperature is an elevated temperature, or wherein the reference temperature is at a temperature in which the material of the first-type layers and second-type layers readily flows.

Embodiment 7. The tubular for fuel delivery of any one of embodiments 2-6, wherein the first-type layers have a Melt Flow Index, MFI₁, wherein the second-type layers have Melt Flow Index, MFI₂, and wherein MFI₁ is different than MFI₂.

Embodiment 8. The tubular for fuel delivery of any one of embodiments 1 and 7, wherein MFI₁ is at least 1.01 MFI₂, at least 1.05 MFI₂, at least 1.1 MFI₂, at least 1.5 MFI₂, at least 2.0 MFI₂, at least 3.0 MFI₂, at least 4.0 MFI₂, at least 5.0 MFI₂, or at least 10.0 MFI₂.

Embodiment 9. The tubular for fuel delivery of any one of embodiments 1, 7, and 8, wherein MFI₁ is no greater than 200.0 MFI₂, no greater than 100.0 MFI₂, or no greater than 50 MFI₂.

Embodiment 10. The tubular for fuel delivery of any one of the preceding embodiments, wherein the first-type layers have a first thickness, wherein the second-type layers have a second thickness, and wherein the first thickness is different than the second thickness.

Embodiment 11. The tubular for fuel delivery of embodiment 10, wherein the first thickness is at least 101% the second thickness, at least 105% the second thickness, at least 110% the second thickness, at least 150% the second thickness, at least 200% the second thickness, or at least 500% the second thickness.

Embodiment 12. The tubular for fuel delivery of embodiment 10, wherein the second thickness is at least 101% the first thickness, at least 105% the first thickness, at least 110% the first thickness, at least 150% the first thickness, at least 200% the first thickness, or at least 500% the first thickness.

Embodiment 13. The tubular for fuel delivery of any one of the preceding embodiments, wherein the tubular is essentially free of weld lines.

Embodiment 14. The tubular for fuel delivery of any one of the preceding embodiments, wherein at least one of the first-type layers and the second-type layers is adapted to provide a barrier against escape of hydrocarbons, alcohols, gases, liquids, or a combination thereof from the tubular.

Embodiment 15. The tubular for fuel delivery of any one of the preceding embodiments, further comprising:

at least one third-type layer.

Embodiment 16. The tubular for fuel delivery of embodiment 15, wherein the at least one third-type layer has a Melt Flow Index, MFI₃, different than a melt flow index of the first-type layer, MFI₁, and second-type layer, MFI₂.

Embodiment 17. The tubular for fuel delivery of embodiment 15, wherein the at least one third-type layer has a Melt Flow Index, MFI₃, has the same melt flow index as at least one of the first-type layer, MFI₁, or second-type layer, MFI₂.

Embodiment 18. The tubular for fuel delivery of embodiment 16, wherein MFI₃ is less than MFI₁ and MFI₂, wherein MFI₃ is between MFI₁ and MFI₂, or wherein MFI₃ is greater than MFI₁ and MFI₂.

Embodiment 19. The tubular for fuel delivery of any one of embodiments 15-18, wherein the at least one third-type layer comprises at least 5 layers, at least 10 layers, at least 20 layers, at least 50 layers, at least 100 layers, or at least 1000 layers.

Embodiment 20. The tubular for fuel delivery of any one of embodiments 15-19, wherein the at least one third-type layer comprises no greater than 10,000 layers, no greater than 5,000 layers, or no greater than 2,000 layers.

Embodiment 21. The tubular for fuel delivery of any one of embodiments 15-20, wherein the at least one third-type layer comprises a layer disposed between a first-type layer and a second-type layer, between adjacent first-type layers, or between adjacent second-type layers.

Embodiment 22. The tubular for fuel delivery of any one of embodiments 15-21, wherein the third-type layer comprises a filler.

Embodiment 23. The tubular for fuel delivery of any one of the preceding embodiments, wherein the tubular comprises at least 20 layers, at least 50 layers, at least 100 layers, at least 200 layers, at least 500 layers, at least 1000 layers, or at least 2000 layers.

Embodiment 24. The tubular for fuel delivery of any one of the preceding embodiments, wherein the tubular comprises no greater than 20,000 layers, no greater than 15,000 layers, no greater than 10,000 layers, or no greater than 5,000 layers.

Embodiment 25. The tubular for fuel delivery of any one of the preceding embodiments, wherein each of the layers has a generally uniform radius as measured around a circumference of the layer with respect to a central axis of the tubular.

Embodiment 26. The tubular for fuel delivery of any one of the preceding embodiments, wherein each of the plurality of first-type layers comprises a thermoplastic, wherein each of the plurality of second-type layer comprises a thermoplastic, or a combination thereof.

Embodiment 27. The tubular for fuel delivery of any one of the preceding embodiments, wherein at least one of the first- and second-type layers comprises poly(methyl methacrylate) (PMMA), acrylonitrile butadiene styrene (ABS), a polyamide, polybenzimidazole (PBI), polycarbonate (PC), polyether sulfone (PES), poly ether ether ketone (PEEK), polyetherimide (PEI), polyethylene (PE), polyphenylene oxide (PPO), polyphenylene sulfide (PPS), polypropylene (PP), polystyrene, polyvinyl chloride (PVC), polyvinylidene fluoride (PVDF), polytetrafluoroethylene (PTFE), styrene ethylene butylene styrene (SEBS), poly(styrene-butadiene-styrene) (SBS), thermoplastic polyurethane (TPU), ethylene vinyl alcohol (EVOH), natural rubber, or a combination thereof.

Embodiment 28. The tubular for fuel delivery of embodiment 27, wherein at least one of the first- and second-type layers comprises a polyamide, a polyvinylidene fluoride (PVDF), a thermoplastic polyurethane (TPU), ethylene vinyl alcohol (EVOH), or a combination thereof.

Embodiment 29. The tubular for fuel delivery of any one of the preceding embodiments, wherein at least one of the first- and second-type layers comprises a filler.

Embodiment 30. The tubular for fuel delivery of any one of the preceding embodiments, wherein the tubular comprises an outer layer disposed along an outermost surface of the tubular, the outermost layer being different from the other layers in thickness, material, porosity, flexibility, elasticity, inertness, or any combination thereof.

Embodiment 31. The tubular for fuel delivery of any one of the preceding embodiments, wherein the tubular comprises an inner layer disposed along an innermost surface of the tubular, the innermost layer being different from the other layers in thickness, material, porosity, flexibility, elasticity, inertness, or any combination thereof.

Embodiment 32. A process of forming a multiplex tubing comprising:

urging a first laminated structure into a first portion of a die;

urging a second laminated structure into a second portion of the die;

continuing urging of the first and second laminated structures such that the first laminated structure forms a first semi-circular geometry and the second laminated structure forms a second semi-circular geometry within the die;

bringing the first semi-circular geometry into contact with the second semi-circular geometry; and

joining the first semi-circular geometry and second semi-circular geometry together.

Embodiment 33. The process of embodiment 32, further comprising:

applying a rotational force along at least one of the first and second semi-circular geometries.

Embodiment 34. The process of embodiment 33, wherein the rotational force is applied simultaneously with joining the first and second semi-circular geometries together.

Embodiment 35. The process of any one of embodiments 33 and 34, wherein the rotational force is applied simultaneously with bringing the first and second semi-circular geometries together.

Embodiment 36. The process of any one of embodiments 33-35, wherein rotational force is applied along an inner surface of the first or second semi-circular geometry, along an outer surface of the first or second semi-circular geometry, or along a combination thereof.

Embodiment 37. The process of embodiment 36, wherein rotational force is applied along the inner surface and the outer surface, and wherein the rotational force along the inner surface is oriented in an opposite direction as compared to the rotational force along the outer surface.

Embodiment 38. The process of any one of embodiments 33-37, wherein rotation is performed in a range of 0.1 revolutions per minute (RPM) to 500 RPM, in a range of 1 RPM to 100 RPM, in a range of 10 RPM to 90 RPM, in a range of 25 RPM to 88 RPM, or in a range of 50 RPM to 85 RPM.

Embodiment 39. The process of any one of embodiments 33-38, wherein rotation is performed in a range of 80 RPM to 85 RPM.

Embodiment 40. The process of any one of embodiments 33-39, wherein rotational force is applied to the first and second semi-circular geometries by at least one surface of the die, wherein the surface is driven by a motor.

Embodiment 41. The process of embodiment 40, wherein the motor is coupled to the surface through one or more pulleys, gears, racks, pinions, screws, other suitable mechanical mechanisms, or a combination thereof.

Embodiment 42. The process of any one of the preceding embodiments, further comprising:

forming the first laminated structure by:
providing a plurality of first-type layers and a plurality of second-type layers;
arranging the first-type layers and second-type layers in a desired arrangement to form a first stack; and
laminating the first stack.

Embodiment 43. The process of any one of the preceding embodiments, further comprising:

forming the second laminated structure by:
providing a plurality of first-type layers and a plurality of second-type layers;
arranging the first-type layers and second-type layers in a desired arrangement to form a second stack; and
laminating the second stack.

Embodiment 44. The process of any one of embodiments 42 and 43, wherein at least one of the first and second laminated structures is generally planar prior to being urged into the die.

Embodiment 45. The process of any one of embodiments 42-44, wherein the first or second stack includes alternating first-type and second-type layers.

Embodiment 46. The process of any one of embodiments 42-45, wherein the desired arrangement for the first stack is the same as the desired arrangement of the second stack.

Embodiment 47. The process of any one of embodiments 42-46, wherein at least one of the first and second stacks comprises at least 5 layers, at least 20 layers, at least 100 layers, at least 500 layers, at least 1000 layers, at least 2000 layers, or at least 5000 layers.

Embodiment 48. The process of any one of embodiments 42-47, wherein at least one of the first and second stacks comprises no greater than 20,000 layers or no greater than 10,000 layers.

Embodiment 49. The process of any one of embodiments 42-48, wherein laminating the first or second stack is performed with application of heat, calendaring, or a combination thereof.

Embodiment 50. The process of any one of embodiments 42-49, wherein at least one of the first and second stacks includes an adhesive disposed between at least two adjacent layers therein.

Embodiment 51. The process of any one of embodiments 42-50, wherein the first portion of the die comprises a first opening and the second portion of the die comprises a second opening, and wherein the first laminated structure is urged into the first opening and the second laminated structure is urged into the second opening.

Embodiment 52. The process of embodiment 51, wherein the first and second openings are generally parallel with one another.

Embodiment 53. The process of any one of embodiments 51 and 52, wherein the first opening has a first lateral side and a second lateral side, and the second opening has a first lateral side and a second lateral side, wherein the first lateral sides of the first and second openings lie along a straight line, wherein the second lateral sides of the first and second openings lie along a second straight line, and wherein the first line is parallel with the second line.

Embodiment 54. The process of any one of embodiments 33-53, wherein joining the first semi-circular geometry and second semi-circular geometry together comprises: welding the first and second semi-circular geometries at circumferential ends.

Embodiment 55. An equipment adapted to form a multiplex tubular, the equipment comprising:

a die comprising:
a first opening and a second opening, the first opening adapted to receive a first laminated structure and the second opening adapted to receive a second laminated structure;
a reshaping portion adapted to reshape the first laminated structure to a first semi-circular geometry and reshape the second laminated structure to a second semi-circular geometry;
a joining element adapted to join the first and second semi-circular geometries together; and
a securing element adapted to secure the first semi-circular geometry and second semi-circular geometry together.

Embodiment 56. The equipment of embodiment 55, wherein the first opening is parallel with the second opening.

Embodiment 57. The equipment of any one of embodiments 55 and 56, wherein at least one of the first and second openings comprises a generally planar opening.

Embodiment 58. The equipment of any one of embodiments 55-57, wherein the die further comprises:

a rotating element adapted to rotate at least a portion of the first semi-circular geometry or a portion of the second semi-circular geometry.

Embodiment 59. The equipment of embodiment 58, wherein the rotating element is adapted to rotate at least one of the first or second semi-circular geometries along an inner surface, an outer surface, or a combination thereof.

Embodiment 60. The equipment of any one of embodiments 58 and 59, wherein the rotating element is adapted to rotate in a range of 0.1 revolutions per minute (RPM) to 500 RPM, in a range of 1 RPM to 100 RPM, in a range of 10 RPM to 90 RPM, in a range of 25 RPM to 88 RPM, or in a range of 50 RPM to 85 RPM.

Embodiment 61. The equipment of any one of embodiments 58-60, wherein rotating element is adapted to rotate at a rate in a range of 80 RPM to 85 RPM.

Embodiment 62. The equipment of any one of embodiments 58-61, wherein the securing element comprises a welding element adapted to melt a circumferential end of the first semi-circular geometry with a circumferential end of the second semi-circular geometry.

Embodiment 63. The equipment of any one of embodiments 58-62, wherein the securing element is disposed adjacent to the joining element.

Embodiment 64. The equipment of any one of embodiments 58-63, wherein the securing element is adapted to secure the first and second semi-circular geometries together at a time substantially simultaneously with the passage of the first and second semi-circular geometries through the joining element.

Embodiment 65. The equipment of any one of embodiments 58-64, wherein at least one of the first opening, the second opening, the reshaping portion, the joining element, and the securing element is detachable from the die.

Embodiment 66. The equipment of any one of embodiments 58-65, wherein at least one of the first opening, the second opening, the reshaping portion, the joining element, and the securing element is interchangeable between a plurality of options, and wherein each of the plurality of options comprises a unique configuration different from the other options.

Embodiment 67. The equipment of embodiment 66, wherein the plurality of options includes at least a first option and a second option, and wherein the first and second options are different in at least one of size, shape, or material.

Embodiment 68. The equipment of any one of embodiments 58-67, wherein the die further comprises an adapter adapted to transfer at least one of the first and second laminated structures to the first or second openings, respectively.

The following examples are provided to better disclose and teach processes and compositions of the present invention. They are for illustrative purposes only, and it must be acknowledged that minor variations and changes can be made without materially affecting the spirit and scope of the invention as recited in the claims that follow.

### EXAMPLES

### Example 1

A thermoplastic polyurethane (Estane 2103-85AE) and an ethylene vinyl alcohol (Soarnol DC3212B) are coextruded to form an alternating 257-layer film with each layer 295 nanometers thick. Total film thickness is 76.2 micrometers. A container containing 40 milliliters of a fuel mixture (45% toluene, 45% isooctane, 10% ethanol) is sealed with a circular section (6.8 centimeters diameter) of the extruded film. The fuel mass loss from the sealed container is measured with time. The results are shown in FIG. 5.

### Comparative Example 2

An alternating 1025-layer film using the same materials in the same amounts as Example 1 is extruded with each layer 74 nanometers thick. Total film thickness is 76.2 micrometers. The fuel mass loss of the film is measured using the same method as Example 1 and is shown in FIG. 5. Comparing Example 2 to Example 1, the 1025-layer film did not have low fuel permeation resistance relative to the 257-layer film. Furthermore, the fuel permeation of the 257-layer film stabilized within 7 days of fuel exposure whereas the fuel permeation of the 1025-layer film continued to change. Therefore, the 257-layer film has the desirable structure to advantageously lower the fuel permeation rate.

### Comparative Example 3

An alternating 3-layer film using the same materials in the same amounts as Example 1 is extruded with each layer 19050 nanometers thick. Total film thickness is 76.2 micrometers. The fuel mass loss of the film is measured using the same method as Example 1 and is shown in FIG. 5. Comparing Example 3 to Example 1, the 3-layer film did not have low fuel permeation resistance relative to the 257-layer film. Furthermore, the fuel permeation of the 257-layer film stabilized within 7 days of fuel exposure whereas the fuel permeation of the 3-layer film remained variable during the 30 days of measurement. Therefore, the 257-layer film has the desirable structure to advantageously lower the fuel permeation rate.

### Example 4

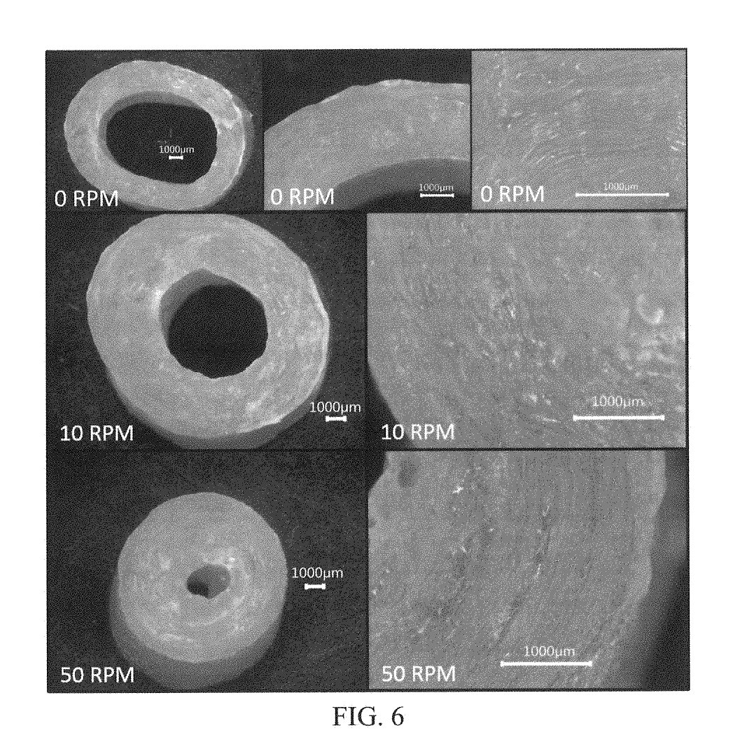

An alternating 65-layer tube using a thermoplastic polyurethane (Desmopan 385EN) and an ethylene vinyl alcohol (Eval L171B) are coextruded in a 50/50 composition to have an individual layer thickness of ˜24,400 nm. Colorants are added to visualize the tube layers. Total tube wall thickness, as defined by the die exit, is 1.5875 mm. Angular rotation of the melt is provided by a rotating die head in the annular land region at levels of 0, 10, and 50 RPM. Extrusion is conducted with the use of a 9-layer feed block, accompanied by three active high aspect ratio multipliers and a fourth multiplier functioning as an adapter to the tubing die. Samples are collected by shearing segments off the die exit into a cooling bath. The results are shown in FIG. 6.

### Example 5

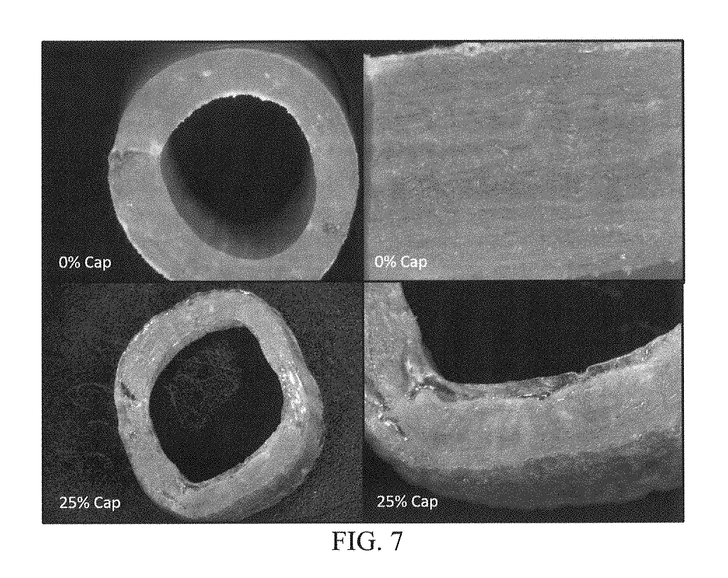

An alternating 129-layer tube of the same materials in the same amounts as Example 4 is extruded with and without the addition of a capping layer of a thermoplastic polyurethane of the same. Thermoplastic polyurethane cap layer compositions are 0% and 25% of the structure. At 0%, the tube dimensions are 14.2 mm-13.2 mm O.D. and 8.1 mm-8.9 mm ID with a wall thickness range of 3.3 mm-2.3 mm. At 25%, the tube dimensions are 14.5 mm-10.9 mm O.D. and 10.2 mm-6.6 mm I.D. with a wall thickness range of 2.3 mm-1.8 mm. An individual layer thickness of the 129-layer structure are ˜12,300 nm and 9,200 nm, for cap layer compositions of 0% and 25%, respectively, based on die exit wall thickness of 1.5875 mm. Extrusion processing and sample collection is conducted in the same method as Example 4, except for the use of four active multipliers and a cap layering feed block inserted between the last active multiplier and adapter. Samples are collected in the same method as Example 4. The results are shown in FIG. 7.

### Example 6

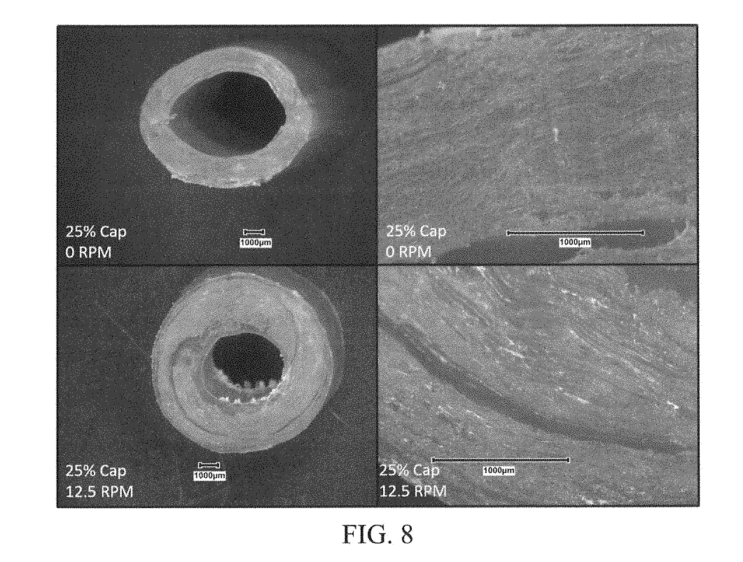

An alternating 129-layer tube of the same materials in the same amounts as Example 5 is extruded with a capping layer of a thermoplastic polyurethane. Angular rotation is applied at levels of 0 and 12.5 RPM. Individual layer thickness of the 129-layer structure is 9,200 nm, based on die exit wall thickness of 1.5875 mm, for both materials in the layer structure at a 50/50 layer composition. At a 25% thermoplastic urethane cap layer, the tube dimensions are 8.4 mm-11.4 mm O.D. and 5.0 mm-8.1 I.D. with a wall thickness range of 2.1 mm-1.4 mm. Extrusion processing is conducted the same as Example 5. Samples are post processed using a vacuum sizing bath and puller and continuous tubing is collected. The results are shown in FIG. 8.

Note that not all of the activities described above in the general description or the examples are required, that a portion of a specific activity may not be required, and that one or more further activities may be performed in addition to those described. Still further, the order in which activities are listed is not necessarily the order in which they are performed.

Certain features that are, for clarity, described herein in the context of separate embodiments, may also be provided in combination in a single embodiment. Conversely, various features that are, for brevity, described in the context of a single embodiment, may also be provided separately or in any subcombination. Further, reference to values stated in ranges includes each and every value within that range.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A tubular for fuel delivery comprising:
a plurality of first-type layers; and
a plurality of second-type layers each disposed between a pair of adjacent first-type layers,
wherein the plurality of first-type layers includes at least two first-type layers, wherein the plurality of second-type layers includes at least two second-type layers, and wherein a Melt Flow Index, MFI₁, of each of the plurality of first-type layers is different than a Melt Flow Index, MFI₂, of each of the plurality of second-type layers, as measured at a same temperature, wherein the tubular for fuel delivery has a resistance to fuel permeation of less than about 15 g/day/m².

2. The tubular for fuel delivery of claim 1, wherein MFI₁ is at least 1.01 MFI₂.

3. The tubular for fuel delivery of claim 1, wherein MFI₁ is no greater than 200.0 MFI₂.

4. The tubular for fuel delivery of claim 1, wherein the first-type layers have a first thickness, wherein the second-type layers have a second thickness, and wherein the first thickness is different than the second thickness.

5. The tubular for fuel delivery of claim 4, wherein the first thickness is at least 101% the second thickness.

6. The tubular for fuel delivery of claim 4, wherein the second thickness is at least 101% the first thickness.

7. The tubular for fuel delivery of claim 1, wherein the tubular comprises at least 20 layers.

8. The tubular for fuel delivery of claim 1, wherein the tubular comprises no greater than 20,000 layers.

9. The tubular for fuel delivery of claim 1, wherein each of the layers has a generally uniform radius as measured around a circumference of the layer with respect to a central axis of the tubular.

10. The tubular for fuel delivery of claim 1, wherein each of the plurality of first-type layers comprises a thermoplastic, wherein each of the plurality of second-type layer comprises a thermoplastic, or a combination thereof.

11. The tubular for fuel delivery of claim 1, wherein at least one of the first- and second-type layers comprises poly(methyl methacrylate) (PMMA), acrylonitrile butadiene styrene (ABS), a polyamide, polybenzimidazole (PBI), polycarbonate (PC), polyether sulfone (PES), poly ether ether ketone (PEEK), polyetherimide (PEI), polyethylene (PE), polyphenylene oxide (PPO), polyphenylene sulfide (PPS), polypropylene (PP), polystyrene, polyvinyl chloride (PVC), polyvinylidene fluoride (PVDF), polytetrafluoroethylene (PTFE), styrene ethylene butylene styrene (SEBS), poly(styrene-butadiene-styrene) (SBS), thermoplastic polyurethane (TPU), ethylene vinyl alcohol (EVOH), natural rubber, or a combination thereof.

12. The tubular for fuel delivery of claim 1, wherein at least one of the first- and second-type layers comprises a polyamide, a polyvinylidene fluoride (PVDF), a thermoplastic polyurethane (TPU), ethylene vinyl alcohol (EVOH), or a combination thereof.

13. The tubular for fuel delivery of claim 1, wherein at least one of the first- and second-type layers comprises a filler.

14. The tubular for fuel delivery of claim 1, wherein the tubular comprises an outer layer disposed along an outermost surface of the tubular, the outermost layer being different from the other layers in thickness, material, porosity, flexibility, elasticity, inertness, or any combination thereof.

15. The tubular for fuel delivery of claim 1, wherein the tubular comprises an inner layer disposed along an innermost surface of the tubular, the innermost layer being different from the other layers in thickness, material, porosity, flexibility, elasticity, inertness, or any combination thereof.

16. A tubular for fuel delivery comprising:
an elongated structure including at least ten layers, the layers comprising:
a plurality of first-type layers; and
a plurality of second-type layers,
wherein the first-type layers have a first viscosity, V₁, as measured at a reference temperature, wherein the second-type layers have a second viscosity, V₂, as measured at the reference temperature, and wherein V₁/V₂ is at least 1.01, wherein the tubular for fuel delivery has a resistance to fuel permeation of less than about 15 g/day/m².

17. The tubular for fuel delivery of claim 16, wherein the reference temperature is an elevated temperature, or wherein the reference temperature is at a temperature in which the material of the first-type layers and second-type layers readily flows.

18. The tubular for fuel delivery of claim 16, wherein the first-type layers have a Melt Flow Index, MFI₁, wherein the second-type layers have Melt Flow Index, MFI₂, and wherein MFI₁ is different than MFI₂.

19. The tubular for fuel delivery of claim 16, further comprising:
at least one third-type layer.

20. A tubular for fuel delivery comprising:
an elongated structure including a plurality of layers, wherein an innermost layer defines an aperture extending along at least a portion of the elongated structure, wherein radially adjacent layers comprise different materials, and wherein the different materials have different viscosities as measured at a same reference temperature, wherein the tubular for fuel delivery has a resistance to fuel permeation of less than about 15 g/day/m².
